(19) United States
(12) Patent Application Publication
(10) Pub. No.: US 2017/0039616 A1
(43) Pub. Date: Feb. 9, 2017

(54) CUSTOMER QUEUE PRIORITIZATION THROUGH LOCATION DETECTION

(71) Applicant: Comenity LLC, Columbus, OH (US)

(72) Inventors: Ramesh KORRA, Hilliard, OH (US); Christian BILLMAN, Gahanna, OH (US); Teresa BREITBACH, Ada, MI (US); Uchenna CHILAKA, Gahanna, OH (US)

(73) Assignee: Comenity LLC, Columbus, OH (US)

(21) Appl. No.: 15/006,759

(22) Filed: Jan. 26, 2016

Related U.S. Application Data
(60) Provisional application No. 62/202,062, filed on Aug. 6, 2015.

(51) Int. Cl. G06Q 30/06; G06Q 10/06

(52) U.S. Cl. CPC G06Q 30/0613; G06Q 10/063118

(57) ABSTRACT

A computer-implemented method for prioritizing customer service is provided. The method includes receiving at a beacon, information that a customer is proximate a retail location, automatically accessing personal information of the customer located at the store location, automatically sending the personal information of the customer information to a sales associate and prioritizing customer service for the customer based on the analyzed personal information while the customer is located at the store location.

### CROSS-REFERENCE TO RELATED APPLICATIONS (PROVISIONAL)

This application claims priority to and benefit of co-pending U.S. Provisional Patent Application No. 62/202,062, filed on Aug. 6, 2015, entitled “INVERTED BEACON” by Ramesh Korra et al. and assigned to the assignee of the present application, the disclosure of which is hereby incorporated herein by reference in its entirety.

### CROSS-REFERENCE TO RELATED U.S. APPLICATIONS

This application is related to co-pending patent application Ser. No. 14/515,853, Attorney docket number ADS-080 entitled “RETAIL CARD APPLICATION”, with filing date of Oct. 16, 2014, assigned to the assignee of the present application and hereby incorporated by reference in its entirety.

This application is related to co-pending patent application Ser. No. 14/584,771, Attorney docket number ADS-059 entitled “COLLECTING AND ANALYZING DATA FROM A MOBILE DEVICE”, with filing date of Dec. 29, 2014, assigned to the assignee of the present application and hereby incorporated by reference in its entirety.

This application is related to co-pending patent application Ser. No. 14/616,448, Attorney docket number ADS-009 entitled “PRIORITIZING CUSTOMER SERVICE”, with filing date of Feb. 6, 2015, assigned to the assignee of the present application and hereby incorporated by reference in its entirety. The co-pending patent application Ser. No. 14/616,448, claims priority to U.S. Patent Application 61/940,749, filed on Feb. 17, 2014, entitled “VIRTUAL CREDIT CARD DISPLAY AND CONSUMER LOCATION DETERMINATION”, by Ainsworth et al., having Attorney Docket No. ADS-009.PRO, and assigned to the assignee of the present application, hereby incorporated by reference in its entirety.

### BACKGROUND

The number of customers located in a store oftentimes outnumbers the number of employees working at the store. Some customers may not receive proper customer service due to the inadequate number of employees currently working at the store. As a result, the customer service may be poor or may not occur to various customers.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 is a block diagram that illustrates an embodiment of a device and payment system in accordance with one embodiment.

FIG. 2 illustrates an embodiment of beacon system in a store in accordance with one embodiment.

FIG. 3 depicts an inverted beacon in a retail store in accordance with one embodiment.

FIG. 4 is a flow diagram of a method for prioritizing customer service in accordance with one embodiment.

FIG. 5 depicts a retail card application system in accordance with one embodiment.

FIG. 6 is a block diagram of a user data collection layer, in accordance with an embodiment.

FIG. 7 depicts a block diagram of an exemplary computer system in accordance with one embodiment.

### DESCRIPTION OF EMBODIMENTS

Reference will now be made in detail to various embodiments, examples of which are illustrated in the accompanying drawings. While various embodiments are discussed herein, it will be understood that they are not intended to be limiting. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding. However, embodiments may be practiced without one or more of these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “identifying,” “receiving,” “downloading,” “accessing,” “using,” “activating,” “managing,” “making,” “displaying,” “generating,” “recording,” “reporting,” “using,” “capturing,” “sending,” “updating,” or the like, often (but not always) refer to the actions and processes of a computer system or similar electronic computing device such as, but not limited to, a portable electronic device, a display unit, an application, an information management system, a payment system, an analytics engine, a point of service (POS) device, a beacon, a wireless transceiver or component thereof.

The electronic computing device manipulates and transforms data represented as physical (electronic) quantities within the electronic computing device's processors, registers, and/or memories into other data similarly represented as physical quantities within the electronic computing device's memories, registers and/or other such information storage, processing, transmission, or/or display components of the electronic computing device or other electronic computing device(s).

### Overview

Retail locations are often not staffed for one associate to help every customer/consumer. Retail locations often prioritize who they will interact with first in order to maximize sales, but using an intuition to determine this priority which may be inaccurate. Embodiments described herein use the signal transmitted by a phone, Bluetooth chip in a credit card, Wi-Fi or other method that is present on a customer to notify another device in the store so that an associate can identify, approach in service the customer.

Embodiments provided include a method for communicating between customer and associate for integration with clienteling. Embodiments described herein provide a tool that uses customer awareness to provide additional detailed or personalized information/data about the customer, such as credit status, previous purchases, size, etc. In one embodiment, the customer is identified through mobile application using a Beacon by sending a signal from the customer's phone and detected by associate device and alerting clienteling so that associates can identify a VIP when they walk-in and approach to sell differently. In one embodiment, the customer is identified through mobile application by using a Beacon to send a signal to the user's phone, which connects to a backend database and alerts the associate device so that associates can identify a VIP when they walk in and approach to sell differently. In general, a beacon is a hardware device that can be detected by mobile devices, and more specifically, by mobile apps running on a user's mobile device.

In another embodiment, the customer is identified through mobile application by a signal sent from the phone, credit card or related device on the consumer to a receiver device in the store. Related devices may include shopping carts, shopping baskets, store provided mobile devices, tablets, telephones, smart jewelry, etc. that have the capability of interacting wirelessly. This device alerts the associate so that associates can identify a VIP when they walk in and approach to sell differently. For example, where the user's phone takes the place of an actual beacon; or using RFID and related technologies.

In one embodiment, a customer is in the store and her identity is provided to a sales associate. For instance, the customers might be in store but a sales associate will likely not know who they are, until they start talking to the customer. Thus, as the customer walks in, the sales associate will know the customer identity and if the customer is a VIP.

In one embodiment, an application on a customer's phone has the logic to retrieve any message for that store, for that customer. Embodiments also include providing additional detail of personalization on the customer, such as credit status, personal preferences for their shopping, size, favorite colors, shipping address etc.

In one embodiment, additional information may also be provided based on customer tracking in the store. Information such as where the customer goes in the store, where the customer stops, slows, or the like. That is, by knowing the portion of the store mostly visited by the customer, information about what the customer is looking for may be deduced. For example, if the customer had previously purchased dress pants, and she is now in the shirt section, the associate may be able to provide a recommendation to the customer about a shirt that would go with the pants.

### Application Layer

In general, a retail card application can be used to replace any plastic credit card. In one embodiment, a downloadable application is provided. The application enables a user to make purchases and manage a credit account via the application. In one embodiment, the application represents a virtual credit card.

In one embodiment, the application represents a retail branded credit card or a private label credit card. In general, a private label credit card is branded for a specific retailer, independent dealer or manufacturer. In some instances, a credit card processor system may process credit card transactions for a number of different retail branded card types.

For example, if the retailer does not manage the private label card, a third-party issues the cards and collects the payments from cardholders. Typically, terms and conditions for private label credit cards are made by contracts between the retailer and the third party. A retailer that provides the private label credit cards provides various incentives, offers, and advantages to its customers which results in a more satisfied customer and/or increased sales. In one embodiment, mobile payment card is branded according to store.

In one embodiment, to accommodate different retail brands, the payment processing system may want to provide a configurable application that can be easily modified according to a brand's preferences. In one embodiment, a configurable application is provided. In one embodiment, the bulk of the backend operating components of the application is generic and a custom or configurable front end is provided that can be custom tailored for a particular brand.

In one embodiment, the application facilitates the transaction phase, meaning the application provides a user interface for making credit account transactions, such as purchases, managing account preferences, managing account rewards programs, buying virtual gift cards, managing promotions, managing information driven enhancements and managing location based loyalty offers.

The result is an application that is easily modified from a basic chassis to give the appearance that the brand has generated a completely customized mobile payment system. This allows the payment processor to provide a unique and custom looking front end payment application without needing to completely develop an application from scratch. The bulk of the application components can be used across different brands and a custom user interface makes the application seem unique to that brand.

### Overview of Clienteling

In the following discussion, clienteling refers to a relationship between a customer referred to hereinafter as a “client”, and a sales associate. Moreover, clienteling may occur at the register or with associates on the sales floor. For example, a customer spends a certain amount while shopping at a certain store. The customer returns to the store at a different time and again spends a minimum amount. The managements will assign an associate to build a client type relationship with the customer-now client.

The relationship will include the associate getting to know the client. For example, the associate would learn information such as, but not limited to the client's: identification information, clothing size, style, taste, likes, dislikes, family members, address, and important dates, such as anniversaries, birthdays, and the like. The associate will then utilize the information about the client to tailor the clients shopping experiences.

For example, the client may contact the associate with a request for an outfit for an upcoming event. The client can describe the event and then the associate could select the appropriate clothes, have the clothes tailored and then have the clothes delivered to the client. In another embodiment, the associate notices that the client's wife's birthday is approaching. The associate could contact the client and let him know about a new product, or a product that the matches the client's wife's taste. The growing relationship between the associate and the client is clienteling.

### System Overview

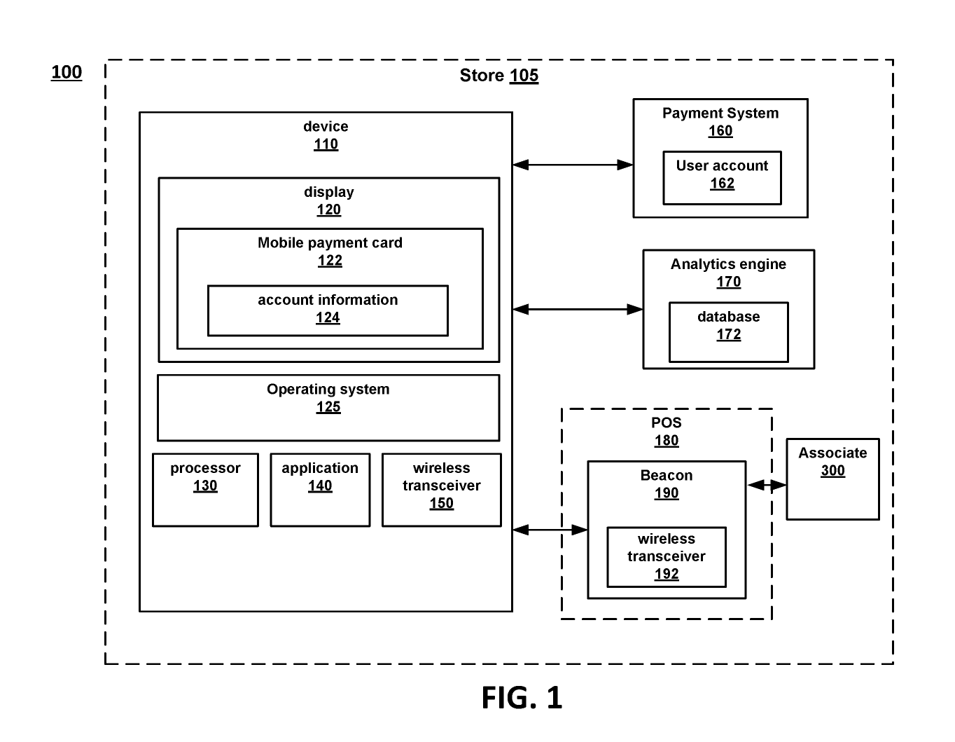

FIG. 1 depicts a block diagram that illustrates an embodiment of system 100. System 100 includes device 110 that is used by a person located at store 105. Device 110 is configured to be communicatively coupled with payment system 160, analytics engine 170, and/or beacon 190, which will be described in further detail below.

Device 110 includes display 120 that is able to display mobile payment card 122. Display 120, in one embodiment, is a touch screen, such that a user is able to interact with displayed features on the touch screen. Device 110 may be a mobile device such as a smart phone, tablet, etc.

Device 110 includes operating system 125. In one embodiment, device 110 is a smart device capable of running applications. The smart device is not limited to any particular make, model or OS platform.

Operating system 125 includes an option (e.g., on/off) as to whether or not to allow automatic low energy (such as a Bluetooth low energy (LE)) connection with device 110. In general, Bluetooth is a wireless technology standard for exchanging data over short distances (e.g., using short-wavelength radio waves in the ISM band from 2.4 to 2.485 GHz) from fixed and/or mobile devices. It is appreciated that embodiments described herein can be used in conjunction with any type of low energy or other radio frequency communication signal and/or standard.

In one embodiment, operating system 125 includes an ON default setting that automatically enables device 110 to have a Bluetooth connection with other devices. As a result, device 110 will automatically accept a Bluetooth invitation from other devices.

For example, beacon 190 transmits a Bluetooth invitation via wireless transceiver 192. If device 110 is in range of the transmitted Bluetooth invitation, then device 110 automatically sends a message back to beacon 190 via wireless transceiver 150 to accept the Bluetooth invitation. Accordingly, there is an automatic Bluetooth connection between device 110 and beacon 190.

Beacon 190 is any device that is configured to be communicatively coupled with device 110. For example, in one embodiment beacon 190 is a NFC enabled device. However, in one embodiment, beacon 190 could be a radio frequency communication signal other than NFC.

In one embodiment, beacon 190 is a low-powered, low-cost transmitter that can notify nearby iOS (Android, or any other OS) devices of their presence. One example of a beacon is an iBeacon™, which is an indoor positioning system from Apple Inc. Although beacon 190 is referred to in one embodiment as being similar to an iBeacon, the use of the iBeacon is provided for purposes of clarity and not as a limitation to the type of beacon 190.

Additionally, a user's mobile app (e.g., application 140) can be enabled to look for the transmission of beacon 190 (or any other beacons). When device 110 is within physical proximity to the beacon and detects it, the application can notify the customer of location-relevant content, promotions, and offers which will be described in further detail below.

Mobile payment card 122 can be any digital payment card that is able to be displayed on display 120 and utilized for purchases. In one embodiment, mobile payment card 122 is implemented via application 140. That is, application 140 (e.g., a mobile application) is downloaded onto device 110. When a user of device 110 selects application 140 to be utilized, processor 130 executes application 140 such that mobile payment card 122 is displayed on display 120. In another embodiment, mobile payment card 122 is supported by being downloaded over the Internet.

In one embodiment, mobile payment card 122 is a mobile credit card or a digital credit card. That is, the mobile payment card 122 is an electronic or digital version of a physical credit card. Mobile payment card 122 can also be referred to as mobile virtual credit card. In one embodiment, the mobile payment card 122 is a payment card directly associated with the store 105, such as a retail-branded credit card that can only be used to make purchases at stores with the same brand as store 105. In one embodiment, the issuer of mobile payment card 122 is the store 105.

In general, a credit card is issued to users or consumers as a system of payment. It allows the cardholder to pay for goods and services based on the holder's promise to pay for them. The issuer of the card creates a revolving account and grants a line of credit to the consumer (or the user) from which the user can borrow money for payment to a merchant or as a cash advance to the user.

In one embodiment, mobile payment card 122 is a branded private label credit card. In general, a private label credit card is branded for a specific retailer, independent dealer or manufacturer. If the retailer does not manage the private label card, a third-party issues the cards and collects the payments from cardholders. Typically, terms and conditions for private label credit cards are made by contracts between the retailer and the third party.

A retailer that provides the private label credit cards provides various incentives, offers, and advantages to its customers which results in a more satisfied customer and/or increased sales. In one embodiment, mobile payment card 122 is branded according to store 105.

In various embodiments, mobile payment card 122 may be a mobile debit card, mobile cash card, mobile gift card, etc.

Mobile payment card 122 includes account information 124. Account information 124 can include, but is not limited to, name of user, billing address, account number, account balance/limit, card provider information, etc.

In one embodiment, account information is optically machine readable information. Optically machine readable information is any machine readable (or scan-able) information that is able to be displayed on display 120 that enables access to or information related to user account 162 of payment system 160.

The optically machine readable information can be displayed in the form of a bar code (1D, 2D), quick response (QR) code, matrix code, etc.

In another embodiment, account information is the account number. For example, the consumer's account number is displayed.

In various embodiments, access to or information related to user account 162 may be accomplished by various means, such as, but not limited to, audio signals, Bluetooth low energy (LE), near field communication (NFC), other radio frequency signals, etc.

Payment system 160 is any payment entity or mechanism that allows for purchases based on mobile payment card 122. For example, payment system 160 is an entity that issued mobile payment card 122 such as a bank, a corporation, etc. In one embodiment, payment system 160 processes retail branded credit card transactions for a plurality of different brands.

In various embodiments, store 105 is a store or location with goods and/or services for sale. It is appreciated that the store 105 could be a virtual store, such as an online shopping store.

While at store 105, the customer is in possession of device 110. Moreover, the customer has a user account 162 associated with store 105. For example, a customer enters a store with the intention to peruse items for sale and potentially purchase items at store 105. The customer also has a private label credit card.

More specifically, application 140 is provided by store 105. For example, application 140 is a mobile application provided by the store.

As such, application 140 enables mobile payment card 122 (e.g., a virtual credit card) to be displayed or surfaced on display 120 of device 110, which will be described in further detail below.

Beacon 190 is at or in proximity to point of sale (POS) 180. When the customer approaches the point of sale (POS), such as a register, with items for purchase, device 110 enters the range of the beacon 190. For example, beacon 190 transmits (e.g., broadcasts) a Bluetooth invitation having a range (e.g., 12-36 inches). Once in the beacon's range, device 110 receives the Bluetooth (e.g., Bluetooth LE) invitation from beacon 190. In response, device 110 sends a signal back to beacon 190 via wireless transceiver 150. As a result, beacon 190 is able to recognize various information associated with device 110 (e.g., phone ID, etc.) and a connection is made between device 110 and beacon 190.

Additionally, in response to device 110 entering in the range of beacon 190 and a connection between device 110 and beacon 190, the consumer is prompted via display 120 if they would like mobile payment card 122 and/or account information 124 to be displayed (or surfaced). In one embodiment, beacon 190 transmits instructions to device 110 to initiate the prompt to the consumer (e.g., the user of device 110).

A specific Beacon could be programed/set up “anywhere” within the retailer's store to trigger via Bluetooth LTE the opening of the “mobile payment card” and thus replacing the existing security requirements of ID/Password resulting in a timelier and user friendly consumer interaction between the merchant and the consumer's mobile payment card. This also allows mobile payments to be transacted where/when the consumer wishes to purchase within the retail store alleviating fixed POS.

If the consumer accepts, then mobile payment card 122 is displayed on display 120. Accordingly, mobile payment card 122 is readily displayed and available to the consumer for immediate purchase of goods/services at POS 180.

In one embodiment, account information 124 is displayed in the form of optically machine readable information (e.g., 2D barcode). As such, an optical scanner (e.g., bar code reader) at POS 180 is able to scan the account information for purchase of the goods/services.

In another embodiment, account information 124 is the account number. As such, the account number is read from display 120 and entered at POS 180 for purchase of the goods/services.

In one embodiment, authentication or security credentials are required prior to display of account information 124. The authentication/security credentials can be but are not limited to a PIN, finger/thumb print, voice command, etc. In one example, a user is prompted to enter a 4 digit PIN. In response to the correct PIN entered, account information 124 is displayed.

### Embodiments of Prioritizing Coverage

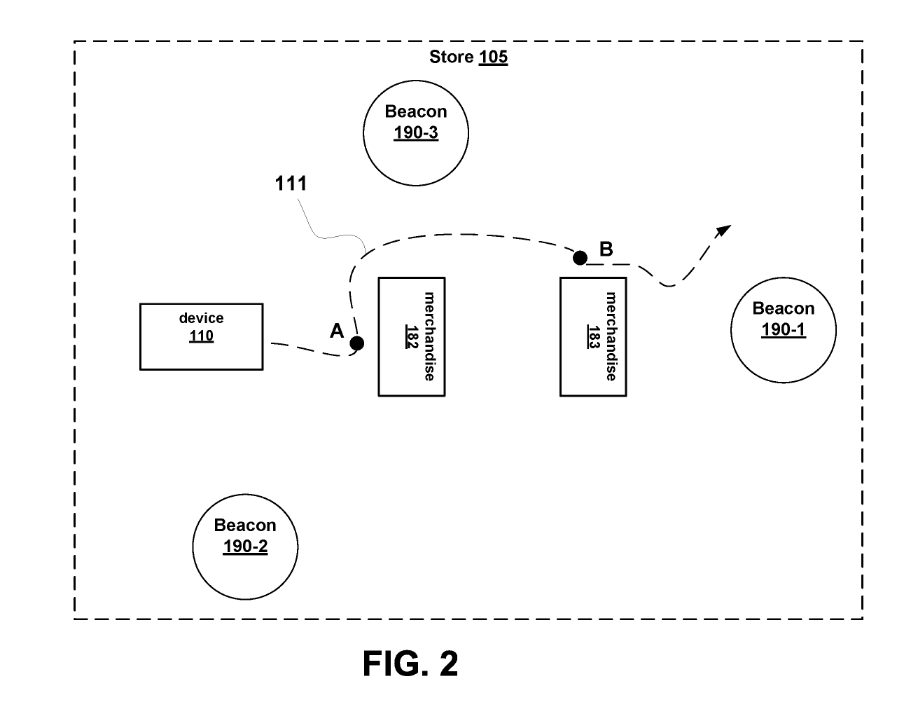

FIG. 2 depicts an embodiment of a block diagram of a consumer in possession of device 110 walking within store 105. Once the consumer enters store 105, device 110 is connected to one or more of beacons 190, 190-1 and 190-2. Although three beacons are depicted, any number of beacons may be employed within store 105 and communicating with device 110.

In response to device 110 being connected with a beacon, various user information associated with the user of device 110 may be obtained. The information may be stored in database 172. The information can be information provided by the user (e.g., name, birthday, address, age, number of children, etc.). The information may be provided via application 140 or during initiation of user account 162.

The user associated information may be any information derived from previous transactions or any other obtained information from various means. More specifically, analytics engine 170 may gather any data associated with the user and analyze such data and generates user associated information. For example, a user may typically purchase items towards the end of the month or on his wife's birthday. Accordingly, analytics engine generate information regarding the user that the user is inclined to purchase other items towards the end of the month or on near his wife's birthday.

It should be appreciated that the obtaining or accessing of user information conforms to applicable privacy laws (e.g., federal privacy laws, state privacy laws, etc.). In one embodiment, prior to accessing user information, the user affirmatively “opts-in” to the services described herein. For example, during an application for the use of the digital credit card, the user is prompted with a choice to affirmatively “opt-in” to various services, such as accessing at least some of the user's personal information or associated data. As a result, the user information is obtained with the user's prior permission.

Additionally, the user is provided with a “seamless” in-store experience (e.g., not being prompted to provide permission to accesses personal information while in the store) because the user affirmatively opted-in to the provided services prior to entering the store.

Additionally, analytics engine 170 may analyze information from thousands of other users and generate purchasing patterns and apply such patterns and analysis to other users. Such information is stored in database 172.

Analytics engine 170 may be a part of customer loyalty program. For example, analytics engine 170 facilitates in the execution a scalable plan to enhance marketing and customer engagement strategies. Also, engine may facilitate growing a business through data-driven loyalty and marketing solutions.

In various scenarios, there are more consumers at store 105 than store employees. It would be beneficial for the store employees to prioritize as to which consumer the employees should invest their time to serve and help the customer.

Prioritization may be accomplished based on the information of the user provided upon the connection between device 110 and one of the beacons. For example, one of the connected beacons is a trigger to obtaining the consumer information which forces a draw of information in database 172 or a calculation of information via analytics engine 170.

More specifically, for example, the information provided by analytics engine 170 indicates that the consumer in possession of device 110 has wife whose birthday is in two days. Therefore it can be presumed that the consumer has high likelihood to be influence-able to purchase an item at store 105.

The employees of store 105 (or sales associates) are provided the consumer's information. For example, the information may be displayed on mobile devices in possession of the store employees.

Based on the provided consumer information, the consumers in the store may be prioritized according to analytics provided by analytics engine 170. For example, the consumer whose wife's birthday in two days may have a higher priority ranking compared to a consumer who has been in the store many times but has rarely purchased any items.

Based on the prioritization of consumers provided to the store employees, the store employees may then make an informed decision on which consumers to invest their time in. For instance, the prioritization indicates that the consumer who may be looking for a gift for his wife is a priority and that the store employees should invest their time on that consumer to enhance conversion.

Moreover, analytics engine 170 may calculate various values for each customer that has a device that connects with a beacon. For example, analytics engine 170 may calculate a customer life value based on various data (e.g., transaction level detail, store visit frequency, consumer patterns in store derived from beacon based measurements, etc.).

Various discounts and incentives to drive offers to consumers may be derived from the values generated by the analytics engine. For example, a promotion may be provided to the consumer for all women's apparel because his wife's soon to be birthday. The promotion may be displayed on display 120.

### Embodiments of Location Determination

Referring to FIG. 2, beacons 190-1, 190-2 and 190-3 may be utilized to determine the customer's proximate location via the connection between the device and the beacons. That is, the beacons may use various methods to determine the location of the consumer within store 105. For example, the system of beacons may use triangulation to determine the exact location of the device. In particular, the device transmits signals to the beacons. The beacons can determine the angles and distance with respect to the device and determine the location of the device within store 105.

The beacons are able to track the consumer while the consumer walks along path 111 throughout the store. For example, the consumer stops at location A to look at merchandise 182 for a duration of time, then moves along path 111 to location B to look at merchandise 183 for a duration of time, and so on.

While in store 105, the consumer is prompted via device 110 that offers are available. For example, an offers button is displayed on display 120. If the user accepts the offers then various offers are displayed to the user.

More specifically, offers are provided to the consumer that relate to the consumer's particular location. For example, while the consumer is at location A, looking at merchandise 182, a promotion or sale for merchandise 182 is provided to the consumer via device 110. Similarly, while consumer is at location A, looking at merchandise 183, a promotion or sale for merchandise 183 is provided to the consumer via device 110.

In another embodiment, consumer has a history of buying a particular item (e.g., brown sweaters) within merchandise 182. This information is provided via analytics engine 170. Accordingly, a promotion for brown sweaters is provided on display 120 while the consumer is at location A in the immediate proximity to brown sweaters.

In general, embodiments described herein include a system that provides offers to a consumer based on consumer location within the store and/or previous consumer actions (e.g., previous purchases, previous paths in store, etc.).

### Embodiments of Analytics Based on Consumer Location

As described above, the system of beacons can track the path of the consumer via device 110. Analytics engine 170 can access the consumer's locations and tracked path and correlate the information with various other consumer related information. As a result, additional analytical information can be generated that is based on the location of the consumer. This information can be utilized as a conversion tool.

In particular, the locations that the consumer stops are determined (e.g., location A and location B). Additionally, the consumer's path 111 is tracked by the beacons and the information is provided to analytics engine 170.

In some embodiments, the consumer's location is determined by the beacons within 12 inches of the consumer's actual location.

In one example, a user is prompted via display 120 that he/she will receive 550 loyalty points if the consumer agrees to being tracked within store 105. As such, in response to accepting the invitation, the consumer receives the additional loyalty points.

Various information may be correlated with the consumer's location to increase conversion. Such information can be, but is not limited to, amount purchased, number of trips to store, shopping on web, etc.

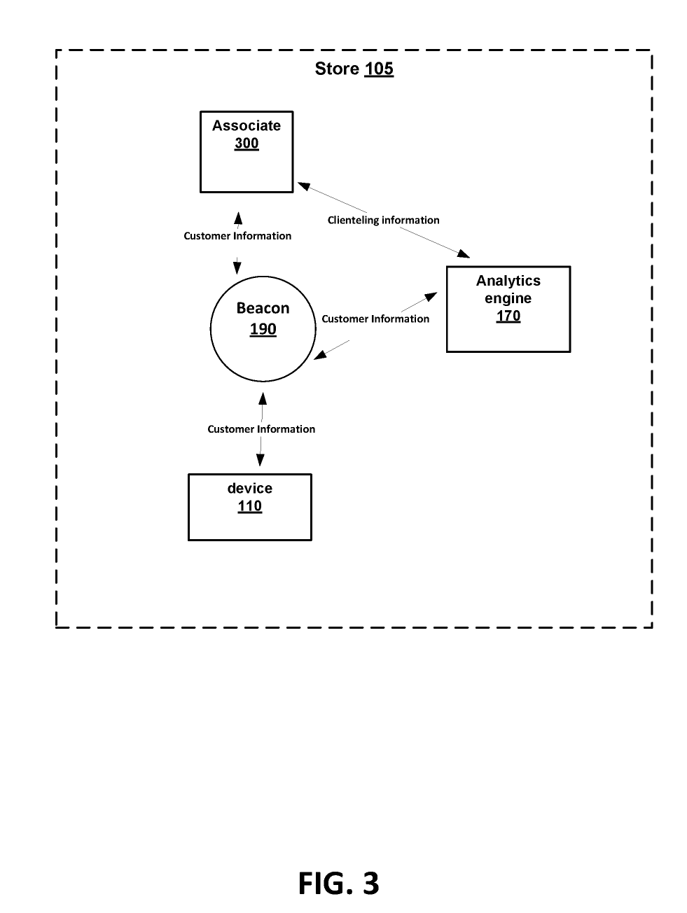

FIG. 3 depicts a beacon 190 in a retail store in accordance with one embodiment. In one embodiment, beacon 190 is an inverted beacon, meaning that the beacon comprises some logic to send and receive information. In one embodiment, a customer device 110 communicates with beacon 190 inside a retail location. The beacon collects customer information and then sends the customer information directly to the sales associate 300 so the associate can identify the customer. In another embodiment, the customer information is sent to analytics engine 170 where the customer information is processed and in one embodiment augmented. The augmented customer information may be part of a clienteling system and/or clienteling data that is then sent to the sales associate so the associate can prioritize customer relations with the customers.

For example, retail locations are often not staffed for one associate to help every customer. Retail locations often prioritize who they will interact with first in order to maximize sales, but using an intuition to determine this priority which may be inaccurate. Embodiments described herein use the signal transmitted by a phone, Bluetooth chip in a credit card, Wi-Fi or other method that is present on a customer to notify another device in the store so that an associate can identify, approach in service the customer.

Embodiments provided include a method for communicating between customer and associate for integration with clienteling. Embodiments described herein provide a tool that uses customer awareness to provide additional detailed or personalized information on the customer, such as credit status, previous purchases, size, etc. In one embodiment, the customer is identified through mobile application using a Beacon by sending a signal from the customer's phone and detected by associate device and alerting clienteling so that associates can identify a VIP when they walk-in and approach to sell differently.

In one embodiment, a customer walks and or being in the store, and embodiments described herein identify who they are. For instance, the customers might be in store but you really don't know who they are, until that if you talk to them. You don't know if somebody is friendly or whoever is a VIP customer standing in front of a certain sales associate.

In one embodiment, an application on a customer's phone have the logic to retrieve any message or for that store, for that customer. Embodiments also include providing additional detail of personalization on the customer, such as credit status, personal preferences for their shopping, it could be their size, favorite colors, maybe even shipping address etc.

### Example Methods of Operation

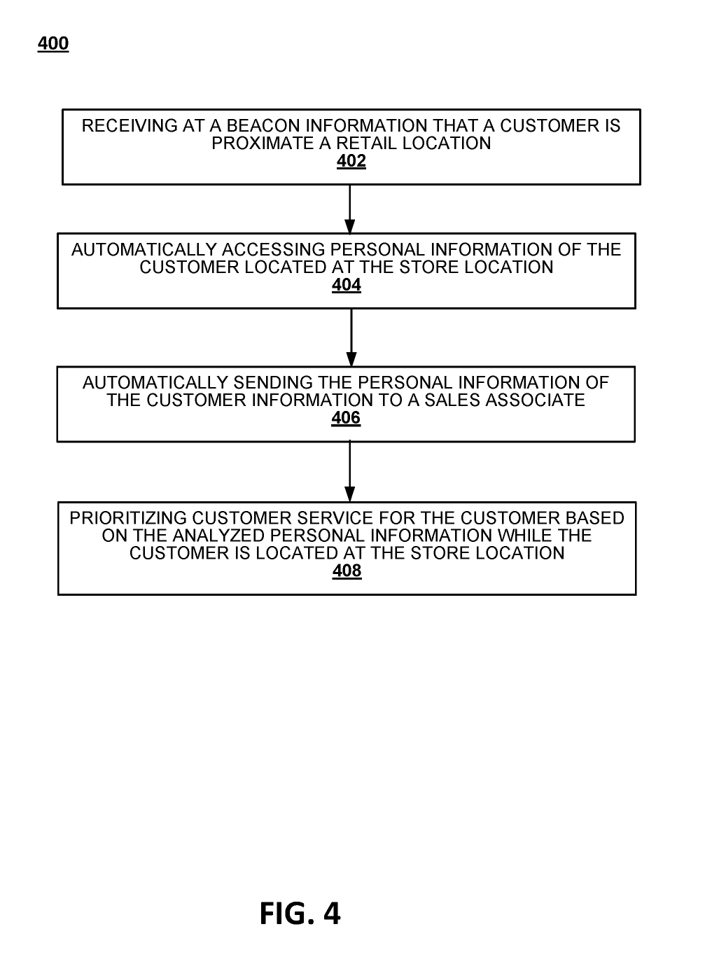

The following discussion sets forth in detail the operation of some example methods of operation of embodiments. With reference to FIG. 4, flow diagram 400 illustrates example procedures used by various embodiments. Flow diagram 400 includes some procedures that, in various embodiments, are carried out by a processor under the control of computer-readable and computer-executable instructions. In this fashion, procedures described herein and in conjunction with flow diagram 400 are, or may be, implemented using a computer, in various embodiments. The computer-readable and computer-executable instructions can reside in any tangible non-transitory computer-readable storage media. Some non-limiting examples of tangible non-transitory computer readable storage media include random access memory, read only memory, magnetic disks, solid state drives/“disks,” and optical disks, any or all of which may be employed with computer environments (e.g. system 700). The computer-readable and computer-executable instructions, which reside on tangible computer readable storage media, are used to control or operate in conjunction with, for example, one or some combination of processors of the computer environments. It is appreciated that the processor(s) may be physical or virtual or some combination (it should also be appreciated that a virtual processor is implemented on physical hardware). Although specific procedures are disclosed in flow diagram 400, such procedures are examples. That is, embodiments are well suited to performing various other procedures or variations of the procedures recited in flow diagram 400. Likewise, in some embodiments, the procedures in flow diagram 400 may be performed in an order different than presented and/or not all of the procedures described in one or more of these flow diagrams may be performed. It is further appreciated that procedures described in flow diagram 400 may be implemented in hardware, or a combination of hardware with firmware and/or software.

FIG. 4 is a flow diagram of a method 400 for prioritizing customer service in accordance with one embodiment.

At 402, method 400 includes receiving at a beacon information that a customer is proximate a retail store location. In one embodiment, the user's location is determined by communicating with a device such as a phone associated with the user. In one embodiment, the phone associated with the user includes an application layer that facilitates communication with a beacon at a retail location.

At 404, method 400 includes automatically accessing personal information of the customer located at the store location. In one embodiment, the beacon receives customer information from the device associated with the user.

At 406, method 400 includes automatically sending the personal information of the customer information to a sales associate. In one embodiment, once the customer information is collected, the customer information is sent to a sales associate to facilitate customer service.

At 408, method 400 includes prioritizing customer service for the customer based on the analyzed personal information while the customer is located at the store location. For example, the client information may indicate the customers ID a VIP and the sales associate prioritizes the VIP's customer service.

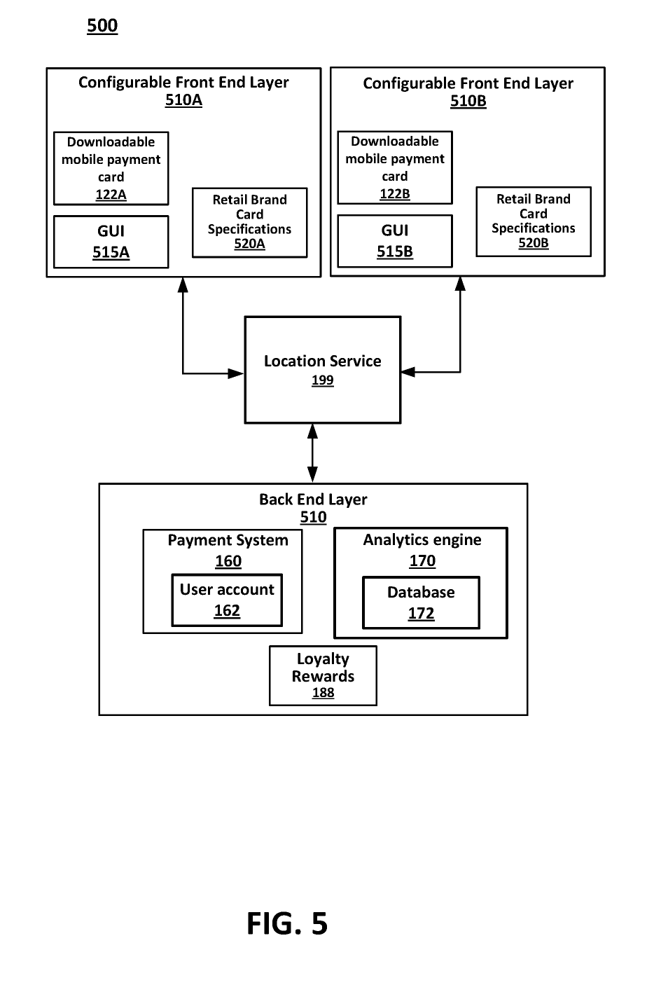

FIG. 5 shows a retail credit card application 500 comprising a back end layer 510, configurable front end layers 510A and 510B and location service 199. It is appreciated that the number of configurable front end layers is unlimited. It is also appreciated that there could be any number of back end layers 510. The location service 199 compiles location information about a user so that targeted rewards offers can be provided to the user to provide information driven enhancement of a user's experience.

In one embodiment, application platform 500 processes a plurality of retail-branded credit cards. The application platform 500 includes a configurable front end (510A and 510B) comprising a graphical user interface layer (515A and 515B) that is configurable to a specific one of the plurality of retail-branded credit card. In one embodiment, the front end layer is configured according to the retail brand card specifications 520A and 520B.

The application platform 500 also includes backend layer 510 comprising credit card functionality (payment system 160) for directly performing credit card transactions associated with the specific one of the plurality of retail-branded credit cards. The payment system 160 includes user account information 162 used for processing credit-based transactions.

In one embodiment, the backend directly performs credit card transactions associated with all of the plurality of retail-branded credit cards. In this example, the payment system 160 processes credit-based transactions associated with more than one retail brand.

In one embodiment, the front end layer 510A includes a downloadable portion for installation on devices associated with users, wherein the downloadable portion can be used directly for approving credit issuance to the user. In this example, a downloadable application can be used to apply for credit. In another embodiment, a user may manage account information related to a line of credit at a retail brand directly from the application.

In one embodiment, the front end 510A provides location specific promotional ads to the user based on location information associated with user. In one embodiment, promotional offers are presented on the user interface 515A and 515B. In one embodiment, the location service 199 facilitates location based shopping enhancement by providing location specific offers and loyalty rewards. In one embodiment, the loyalty rewards module 188 uses account information in combination with location information to drive location based rewards offers to users.

In one embodiment, the front end provides reward points to the user in response to the user completing a transaction using a specific one of a plurality of retail-branded credit cards.

In one embodiment, the front end provides a payment interface that enables the user to pay a bill associated with a specific one of the plurality of retail-branded credit cards. The payment may be processed via payment system 160.

In one embodiment, the front end provides a mobile receipt associated a transaction using a specific one of the plurality of retail-branded credit cards to the user. In one embodiment, the user account 162 stores transaction receipts in a form that can be provided to the user on GUI 515A and 515B.

In one embodiment, the front end provides a gift card store front that enables a user to purchase a gift card using a specific one of the plurality of retail-branded credit cards. In one embodiment, a gift card can be purchased in the name of the gift recipient and the recipient will receive a virtual credit card in their name.

In another embodiment, application platform 500 can be used directly for creating a credit account for a user. In another embodiment, application platform 500 can be used directly for using earned credit card rewards points associated with a user. In another embodiment, application platform 500 can be used directly for buying items at a store associated with the specific one of the plurality of retail-branded credit cards. In one embodiment, application platform 500 can be used directly for receiving promotions associated with the specific one of the plurality of retail-branded credit cards.

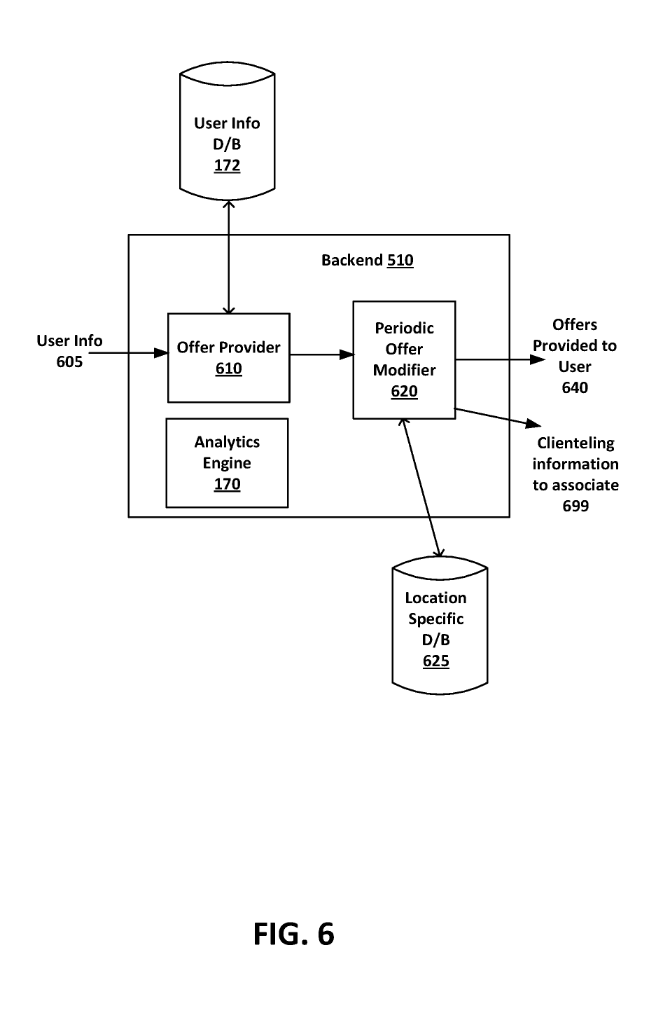

FIG. 6 shown an exemplary backend layer 510 that receives user information 605 from mobile devices associated with users of a credit card. In one embodiment, the user information is collected with the knowledge and consent of the user with the understanding that providing the information can result in personalized incentive offers. The collected user information is stored in a user info database 172.

The backend 510 also includes an offer provider 610 that uses analytics engine 170 and the information in database 172 to generate offers to the user. In one embodiment, the analytics engine determines at least one buyer attribute that can be used to deliver offers 640 to the user. In one embodiment, the analytics engine determines at least one buyer attribute that can be used to deliver clienteling information 699 to a sales associate so the associate can prioritize customer service.

In one embodiment, the analytics engine provides clienteling information such as credit status, previous purchases, size, etc. In one embodiment, the customer is identified through mobile application using a Beacon by sending a signal from the customer's phone and detected by associate device and alerting clienteling so that associates can identify a VIP when they walk-in and approach to sell differently.

Periodically, the offers are modified by the periodic offer modifier 620. For example, in one embodiment, location specific offers can be presented to the user with the aid of the location specific database 625. When a particular user shares his location, location specific offers from the location specific database 625 can be delivered to the user.

In one embodiment, offers 640 provided to the user include the ability to target out contextually relevant messages to a user based on time, location or where that person is, so instead of just blasting e-mail or putting something out here, the user is delivered a contextually relevant information delivered to them at the right time and location to drive action on that purchase.

Using this time and location in sending you the example used, maybe you get something on your mobile two weeks prior to a sale within a text, the day before the sale, an in-store or even more contextually relevant because it's using your location.

One embodiment provides a kind of consumer journey but they are getting the right messages at the right time and they resonate with the user.

One embodiment includes pushing a message to that mobile commerce (M-Commerce) site so that when you go to the M-Commerce site and you're on a certain page, the backend layer can send a user a pop-up message that they will only see on their mobile device. This would be at the E-Commerce site.

### Exemplary Computer System

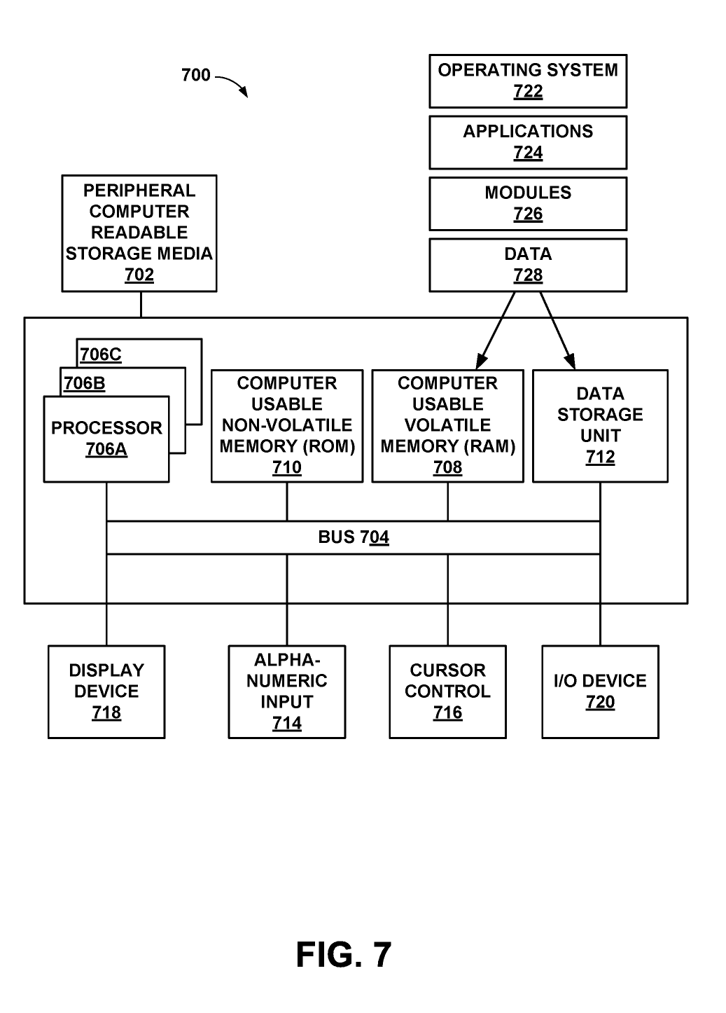

With reference now to FIG. 7, all or portions of some embodiments described herein are composed of computer-readable and computer-executable instructions that reside, for example, in computer-usable/computer-readable storage media of a computer system. That is, FIG. 7 illustrates one example of a type of computer system that can be used in accordance with or to implement various embodiments which are discussed herein. It is appreciated that computer system 700 of FIG. 7 is only an example and that embodiments as described herein can operate on or within a number of different computer systems including, but not limited to, general purpose networked computer systems, embedded computer systems, server devices, various intermediate devices/nodes, stand alone computer systems, handheld computer systems, multi-media devices, and the like.

Computer system 700 of FIG. 7 is well adapted to having peripheral computer-readable storage media 702 such as, for example, a floppy disk, a compact disc, digital versatile disc, universal serial bus “thumb” drive, removable memory card, and the like coupled thereto.

Computer system 700 of FIG. 7 includes an address/data bus 704 for communicating information, and a processor 706A coupled to bus 704 for processing information and instructions. As depicted in FIG. 7, computer system 700 is also well suited to a multi-processor environment in which a plurality of processors 706A, 1006B, and 706C are present. Conversely, computer system 700 is also well suited to having a single processor such as, for example, processor 706A. Processors 706A, 706B, and 706C may be any of various types of microprocessors. Computer system 700 also includes data storage features such as a computer usable volatile memory 708, e.g., random access memory (RAM), coupled to bus 704 for storing information and instructions for processors 706A, 706B, and 706C.

Computer system 700 also includes computer usable non-volatile memory 710, e.g., read only memory (ROM), and coupled to bus 704 for storing static information and instructions for processors 706A, 706B, and 706C. Also present in computer system 700 is a data storage unit 712 (e.g., a magnetic or optical disk and disk drive) coupled to bus 704 for storing information and instructions. Computer system 700 also includes an optional alphanumeric input device 714 including alphanumeric and function keys coupled to bus 704 for communicating information and command selections to processor 706A or processors 706A, 706B, and 706C.

Computer system 700 also includes an optional cursor control device 716 coupled to bus 704 for communicating user input information and command selections to processor 706A or processors 706A, 706B, and 706C. In one embodiment, computer system 700 also includes an optional display device 718 coupled to bus 704 for displaying information.

Referring still to FIG. 7, optional display device 718 of FIG. 7 may be a liquid crystal device, cathode ray tube, plasma display device, projector, or other display device suitable for creating graphic images and alphanumeric characters recognizable to a user. Optional cursor control device 716 allows the computer user to dynamically signal the movement of a visible symbol (cursor) on a display screen of display device 718 and indicate user selections of selectable items displayed on display device 718. Many implementations of cursor control device 716 are known in the art including a trackball, mouse, touch pad, joystick or special keys on alphanumeric input device 714 capable of signaling movement of a given direction or manner of displacement. In another embodiment, a motion sensing device (not shown) can detect movement of a handheld computer system.

Examples of a motion sensing device in accordance with various embodiments include, but are not limited to, gyroscopes, accelerometers, tilt-sensors, or the like. Alternatively, it will be appreciated that a cursor can be directed and/or activated via input from alphanumeric input device 714 using special keys and key sequence commands. Computer system 700 is also well suited to having a cursor directed by other means such as, for example, voice commands. In another embodiment, display device 718 comprises a touch screen display which can detect contact upon its surface and interpret this event as a command. Computer system 700 also includes an I/O device 720 for coupling computer system 700 with external entities. For example, in one embodiment, I/O device 720 is a modem for enabling wired or wireless communications between system 700 and an external network such as, but not limited to, the Internet.

Referring still to FIG. 7, various other components are depicted for computer system 700. Specifically, when present, an operating system 722, applications 724, modules 726, and data 728 are shown as typically residing in one or some combination of computer usable volatile memory 708 (e.g., RAM), computer usable non-volatile memory 710 (e.g., ROM), and data storage unit 712. In some embodiments, all or portions of various embodiments described herein are stored, for example, as an application 724 and/or module 726 in memory locations within RAM 708, computer-readable storage media within data storage unit 712, peripheral computer-readable storage media 702, and/or other tangible computer-readable storage media. In one embodiment, Application 140 of FIG. 1 is at least partially stored in applications 724.

Example embodiments of the subject matter are thus described. Although various embodiments of the have been described in a language specific to structural features and/or methodological acts, it is to be understood that the appended claims are not necessarily limited to the specific features or acts described above. Rather, the specific features and acts described above are disclosed as example forms of implementing the claims and their equivalents. Moreover, examples and embodiments described herein may be implemented alone or in various combinations with one another.

1. A computer-implemented method for prioritizing customer service comprising:
receiving at a beacon information that a customer is proximate a retail store location;
automatically accessing a personal information of said customer located at said retail store location;
automatically sending said personal information of said customer to a sales associate; and
prioritizing customer service for said customer based on said personal information while said customer is located at said retail store location.

2. The computer-implemented method of claim 1, further comprising:
automatically displaying said personal information for viewing by a store employee at said retail store location.

3. The computer-implemented method of claim 1, wherein said automatically accessing personal information further comprises:
automatically accessing personal information from a mobile device in possession of said customer.

4. The computer-implemented method of claim 1, wherein said automatically accessing personal information further comprises:
automatically accessing personal information by a beacon located at said retail store location.

5. The computer-implemented method of claim 1, wherein said automatically accessing personal information further comprises:
automatically accessing personal information from a database.

6. The computer-implemented method of claim 1, wherein said automatically accessing personal information further comprises:
automatically accessing personal information of a plurality of customers from a plurality of respective mobile devices at said retail store location.

7. The computer-implemented method of claim 1, further comprising:
calculating a metric for said customer based on said personal information.

8. The computer-implemented method of claim 1, further comprising:
generating a promotion for said customer based on said personal information.

9. The computer-implemented method of claim 8, further comprising:
displaying said promotion on a mobile device in possession of said customer while said customer is located at said retail store location.

10. A non-transitory computer-readable storage medium having instructions embodied therein that when executed cause a computer system to perform a method prioritizing customer service, the method comprising:
receiving at a beacon information that a customer is proximate a retail store location;
automatically accessing a personal information of said customer located at said retail store location;
prioritizing customer service for said customer based on said personal information while said customer is located at said retail store location; and
automatically sending said prioritizing to a sales associate.

11. The non-transitory computer-readable storage medium of claim 10, further comprising:
automatically displaying said personal information for viewing by a store employee at said retail store location.

12. The non-transitory computer-readable storage medium of claim 10, wherein said automatically accessing personal information further comprises:
automatically accessing personal information by a beacon located at said retail store location.

13. The non-transitory computer-readable storage medium of claim 10, wherein said automatically accessing personal information further comprises:
automatically accessing personal information from a database.

14. The non-transitory computer-readable storage medium of claim 10, wherein said automatically accessing personal information further comprises:
automatically accessing personal information of a plurality of customers from a plurality of respective mobile devices at said retail store location.

15. The non-transitory computer-readable storage medium of claim 10, further comprising:
calculating a metric for said customer based on said personal information.

16. The non-transitory computer-readable storage medium of claim 10, further comprising:
generating a promotion for said customer based on said personal information.

17. The non-transitory computer-readable storage medium of claim 16, further comprising:
displaying said promotion on a mobile device in possession of said customer while said customer is located at said retail store location.

18. An application platform that uses a customer's proximate location to a retail store to access a customer's personalized data and prioritize customer service for a customer comprising:
a configurable front end comprising a graphical user interface layer that is configurable to a retail store location and configured to receive from a beacon located at said retail store location an indication that said customer is proximate said retail store location;
a data collection layer comprising a database accessor to automatically interact with a database containing said customer's personalized data; and
an analytics engine coupled with the data collection layer to determine one or more attributes about said customer from said customer's personalized data, said analytics engine to prioritize customer service for said customer based on said attributes while said customer is located at said retail store location.

19. The application platform of claim 18 further comprising:
a downloadable portion for installation on a mobile device associated with said customer, wherein said downloadable portion includes functionality for providing customer information to said data collection layer.

20. The application platform of claim 18 further comprising:
a downloadable portion for installation on a mobile device associated with a store associate, wherein said downloadable portion provides functionality for identifying said customer.

21. The application platform of claim 18 wherein said analytics engine calculates a metric for said customer based on said attributes and generates a promotion for said customer based on said attributes.
